(19) United States
(12) Patent Application Publication
(10) Pub. No.: US 2010/0154115 A1
(43) Pub. Date: Jun. 24, 2010

(54) Aid Apparatus

(75) Inventors: Göran Wernqvist, Enskede (SE); Peter Svensson, Tyreso (SE); Susanne Wedbjer, Solna (SE); Björn Wernqvist, Hagersten (SE)

Correspondence Address: POTOMAC PATENT GROUP PLLC, P. O. BOX 270, FREDERICKSBURG, VA, 22404, US

(73) Assignee: SHL MEDICAL AB, Nacka Strand (SE)

(21) Appl. No.: 12/160,745

(22) PCT Filed: Jan. 4, 2007
(86) PCT No.: PCT/EP07/50094

§ 371 Date: Sep. 2, 2008

Related U.S. Application Data
(60) Provisional application No. 60/758,462, filed on Jan. 12, 2006.

(30) Foreign Application Priority Data
Jan. 13, 2006 (SE) 0600049-1

(51) Int. Cl. A61G 7/10

(52) U.S. Cl. 5/86.1

(57) ABSTRACT

The present invention relates generally to an aid apparatus for enabling the assisted mobility of a disable person e.g. to be raised from a sitting position to a standing position, transferring and vice versa. The aid apparatus comprises: a wheeled base frame means; a support column means comprising a handgrip (31); a lifting mechanism means comprising a sling (80), including a waist strap (81) and thigh strap; a U-shaped lifting arm (40) with attaching means (42) carrying said sling (80) and an actuator (45); and/or a control box means (50); wherein the handgrip (31) is positioned on the slightly inclined column (30) at a distance that encourage a seated patient to hold on to it so that his centre of gravity is shifted forward; and the U-shaped lifting arm (40) is designed for being moved by an actuator (45), whereby due to the patient shifted centre of gravity, the movement of the U-shaped lifting arm (40) transfers components of motion with which the patient can be displaced following an ergonomic movement path.

### TECHNICAL FIELD

The present invention relates generally to an aid apparatus for enabling the assisted mobility of a disable person e.g. to be raised from a sitting position to a standing position, transferring and vice versa.

### BACKGROUND ART

Today, there is a large number of patients; e.g. disable, old and physically challenged persons; who are limited to beds, wheelchairs, chair or toilets and who need the assistance of care givers; e.g. therapists, relatives; to help them to a standing position from a sitting position or to help them to be transferred from a bed and/or a wheelchair.

Some of these patients live in special living homes and other in their ordinary homes. The special living homes are becoming twice as costly as home care. It is not hard to predict that the costs for special care within the near future will raise due to the increasing number of elderly people. Therefore, it would be very profitable for the society if the elderly people could be taken care of in their home environment as long as possible with the care being performed by relatives in the homes, such as a husband or a wife. This would also very much likely be appreciated by the family concerned.

There are however a number of presumptions for the elderly person to remain at home. For instance, the environment must be safe and secure, comfortable and functionally adapted. For a person with reduced capability and disability a big concern is the concept of raising from a sitting position into a standing position.

Such attempts are often avoided both from the patients and the care givers due to the fear that the patients can fall and receive lesions. When such attempts are done, sometimes the patients are so heavy that the care givers may injury themselves and/or may in a lapse of time result in muscle strains and back injuries.

In order to solve these problems, numerous devices, which assist the patients, have been developed. Nowadays, some of these devices make use of slings, or the like, which hold and secure the patient and lifting mechanisms, which enable the patient to be moved from a sitting position to a standing position in a walking or transferring device.

U.S. Pat. No. 6,568,002 discloses an aid apparatus for raising a disabled person from a sitting position to a standing position, which apparatus includes a wheeled base and a lifting arm having a free end, which supports a lifting sling brought round the body of a disable person, approximately at breast-high.

U.S. Pat. No. 6,389,619 discloses a sit-to-stand lift that can cause a person to follow a natural path of standing up and sitting down. During standing up, the most natural path comprises of carrying the body above the feet by a substantially horizontal movement in forward direction of the person, where after the body is brought into a standing position by a substantially vertical movement, wherein the shoulders describe a concave, elliptical path. This path can be followed in reverse direction when sitting down. The existing sit-to-stand lift makes use of an articulated carrying body which consists of two arms pivotally connected to each other and which moves along the desired path through a compound movement of the two arms of the part of the carrying body adapted to engage on the person, for instance handgrips or a sling. A drawback of this apparatus is that the movements of the two arms must be adjusted very precisely to each other. The apparatus is therefore relatively complex and in general relatively susceptible to malfunction and expensive to produce. The slings are place under the arms of a patient and the patient is leaning backward, which causes an unpleasant feeling of insecurity to the patient.

U.S. Pat. No. 6,175,973 discloses an apparatus for assisting a person in achieving a standing position. The apparatus include a base, a frame extending upward from the base, a lifting arm pivotally coupled to the frame, a platform upon which a person can stand, and an actuator which is controlled to raise and lower the lifting arm. The apparatus also includes a sling assembly which is removably attachable to the lifting arm. The sling assembly is designed to encircle the body of a person. The sling assembly also includes at least one caregiver handle on an outer back portion thereof.

U.S. Pat. No. 6,135,131 discloses a device for use in cooperation with an apparatus for lifting a person from the seated position to a standing position wherein the apparatus has at least one hollow handle extending downwardly when the person is in a standing position. A harness is strapped to and secured around the back of an individual.

These lifting and/or transferring devices suffer from a number of drawbacks e.g.:

the physical size of these devices is so large that it is almost impossible to maneuver and pass through narrow door passages;

uncomfortable slings that are place under the arms of a patient, making the patient to lean backward, which causes an unpleasant feeling of insecurity to the patient, when he is raised from a sitting position to a standing position;

many complicated adjustable parts of the devices;

none forward movement of a patient's upper body as is natural or too high pressure exerted by a patient's body against the knee pads;

none of these devices is intended to be used in wet rooms.

While there have been proposed a variety of lifting and/or transferring devices including different types of solutions, such as described above, each have their own shortcomings, some of which have been detailed above, as well as shortcomings being universal for all the above-described systems. Generally, heretofore, there has not been available a single concept which solves the above-mentioned problems.

### DISCLOSURE OF INVENTION

One object of the present invention is to provide a relatively simple aid apparatus of the type stated in the preamble, with which patients can be displaced following an ergonomic movement path from a sitting position to a standing position and vice versa.

Another object of the present invention is to provide a relatively simple aid apparatus of the type stated in the preamble, which is homely acceptable designed in order to facilitate for patients to move through narrow passageways and obstacles, such as doorways and doorsteps.

A further object of the present invention is to overcome other shortcomings and problems of the lifting and/or transferring devices heretofore available in the industry discussed above.

These and other objects are obtained according to the present invention by providing an aid apparatus of the type stated in the preamble having the features defined in the independent claim. Preferred embodiments are defined in the dependent claims.

According to an aspect of the present invention, there is provided an aid apparatus for raising a patient from a sitting position to a standing position, transferring and vice versa comprising:

a wheeled base frame means;

a support column means comprising a slightly inclined column towards the front end of the wheeled base frame and a handgrip positioned on the slightly inclined column at a distance that encourage a seated patient to hold on to it so that his centre of gravity is shifted forward;

a lifting mechanism means comprising a sling consisting of a waist strap and a thigh strap, an U-shaped lifting arm consisting of two laterally spaced arms and one pivoted horizontal cross arm, a pair of attaching means positioned at the outer ends of the two laterally spaced arms for attaching the sling; wherein the U-shaped lifting arm is designed for being moved by the actuator in order to lift the patient from a sitting position into a standing position, whereby due to the patient shifted centre of gravity, the movement of the U-shaped lifting arm transfers a slightly backward component of motion to the shins of the patient, a slightly forward component of motion to the waist strap and a major upward component of motion to the thigh strap.

This solution provides the advantage that a patient follows an ergonomic movement path, which is characterized in that the upper body of a patient involves a slightly forward movement and a major upward movement. Moreover, the slightly backward component of motion imparted to the shins of the patient and the above mentioned components of motion imparted to the upper body of the patient by the straps minimize strains on the knees, shins, hip joints and on the pelvis.

In a preferred embodiment the above effect is achieved by:

positioning the upper shins of the patient to make a slightly contact towards a shin pad (35) and consequently being ensured that the aid apparatus is in place,

having the handgrip (31) positioned on the slightly inclined column (30) at a distance that encourage the seated patient to hold on to it so that his centre of gravity is shifted forward,

having the horizontal cross arm of the U-shaped lifting arm (40) positioned at a substantially sane level as the knees of the seated patient,

positioning the two laterally spaced arms of the U-shaped lifting arm (40) substantially parallel to the thighs of the seated patient,

attaching the sling (80) to the attaching means (42) of the U-shaped lifting arm (40), wherein the waist strap (81) is surrounded and secured around the waist of the patient and the thigh strap (82) is positioned under the thighs of the patient, secured to the waist strap (81) and attached to the attaching means (42) of the U-shaped lifting arm (40).

According to another aspect of the present invention, there is provided an aid apparatus comprising a wheeled base frame means, a support column means, a lifting mechanism means and a control box means, wherein the dimensions of said means are designed in order to facilitate for patients to move through narrow passageways, such as doorways.

Further, a control box means (50) and the heaviest part of a power driven linear actuator are positioned at the lowest end of the column support means in order to obtain a lower centre of gravity and a more homely accepted design.

According to another aspect of the present invention, there is provided an aid apparatus comprising a wheeled base frame means, a support column means, a lifting mechanism means and a control box means, wherein the slightly inclined column (30), a pair of bracket plates (33), a part of the U-shaped lifting arm (40); the pair of bracket sleeves (41), the actuator (45) and/or the control box means (50) are covered by a waterproof cover (60). Further, all metallic components and joints are treated according to well known methods to avoid corrosion. Thus, it will make easier for the patient to even use said aid apparatus in wet rooms.

According to another aspect of the present invention, there is provided an aid apparatus comprising a wheeled base franc means, a support column means, a lifting mechanism means and a control box means, wherein a footplate (16), which is attached to the wheeled base frame, allows the patient to be transferred by a care giver. If the aid apparatus is to be used as a rehabilitation device, the footplate (16) can be removed or pivoted about some hinges before the patient is to be lifted.

According to another aspect of the present invention, there is provided an aid apparatus comprising a wheeled base frame means, a support column means, a lifting mechanism means and a control box means, wherein front castor means and rear castor means, which are adapted to be attached to the wheeled base frame means, comprise wheels designed so that the wheels of the front castor means have a larger diameter than the wheels of the rear castor means. This solution provides the advantage to the aid apparatus to pass over obstacles as doorsteps by a simple manner.

The features that characterize the invention will be better understood from the following description used in conjunction with the accompanying drawings. It is to be expressly understood that the drawings is for the purpose of illustration and description and is not intended as a definition of the limits of the invention. These and other objects attained, and advantages offered, by the present invention will become more fully apparent as the description that now follows is read in conjunction with the accompanying drawings.

### BRIEF DESCRIPTION OF DRAWINGS

FIG. 1 is a perspective view of a preferred embodiment of an aid apparatus according to the present invention.

FIG. 1a is a side view of an aid apparatus from FIG. 1.

FIG. 1b is a rear view of an aid apparatus from FIG. 1.

FIG. 1c is a top view of the aid apparatus illustrated in FIGS. 1 to 3.

FIG. 2 is a top view of a preferred embodiment of a sling according to the present invention.

FIG. 2a is a perspective front view of a patient wearing the sling from FIG. 2.

FIG. 2b is a perspective rear view of a patient wearing the sling from FIG. 2.

FIG. 3 is a perspective view of an aid apparatus provided with a waterproof cover.

FIG. 4 is a side view showing a sitting patient taking hold of the handgrip of the aid apparatus in preparation to be raised to a standing position.

FIG. 4a is a side view showing a sitting patient in transfer to standing position and the forces that actuate on the patient.

FIG. 4b is a side view showing a patient in a half standing position.

FIG. 4c is a side view showing a patient in a standing position.

FIG. 5 is a perspective view of another embodiment of an aid apparatus according to the present invention.

FIG. 6 is a top view of another embodiment of the sling according to the present invention.

### DETAILED DESCRIPTION OF THE INVENTION

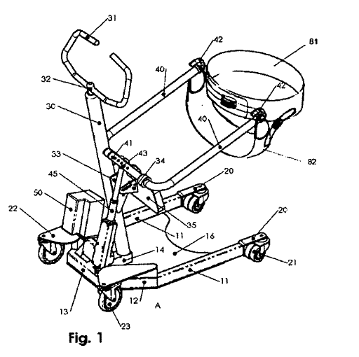

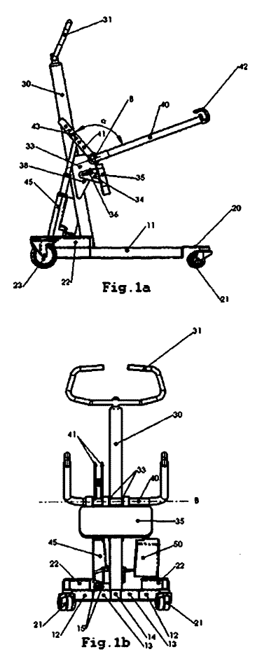

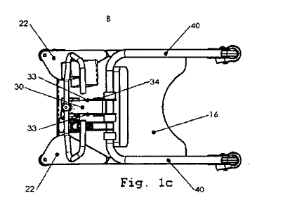

Referring to the FIGS. 1 to 1c, the aid apparatus illustrated therein comprises a wheeled base frame means, a support column means, a lifting mechanism means and a control box means.

The wheeled E-shaped base frame means comprises a base frame (10).

In one embodiment, the base frame (10) comprises two outer legs (11), two beveled legs (12), a front leg (13), a middle leg (14) and a footplate (16), which is arranged between the two outer legs (11). The two outer legs (11), which are parallel to one another and with a predetermined length, extends from the open end of the base frame in a longitudinally direction until they are bended inwards a predetermined angle and having a predetermined length, hereunder the two beveled legs (12). The two beveled legs (12) are bended inwards again in order to form the front leg (13) at the closed end of the base fame (10). Finally, the middle leg (14) extends longitudinally from the middle part of the front leg (13) and wherein said middle leg (14) has a length (A) as illustrated in FIG. 1.

In another embodiment, the base frame (10) is a U-shaped frame comprising two outer legs (11) and a middle leg (14) that extends longitudinally from the middle part of the U-shaped frame and wherein said middle leg (14) has a length (A) as illustrated in FIG. 1.

In one embodiment, the footplate (16), which is arranged between the two outer legs (11), can be detachable, wherein the base frame (10) is provided with suitable guide means to attach/detach said footplate by a simple manner (not illustrated).

In another embodiment, the footplate (16), which is arranged between the two outer legs (11), can be divided in two parts, wherein each part is attached to the base frame (10) by hinges (not illustrated).

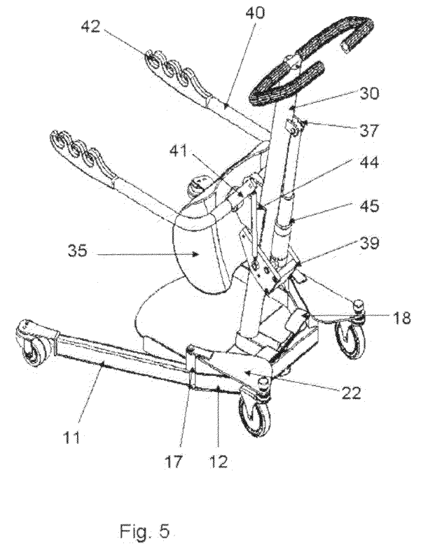

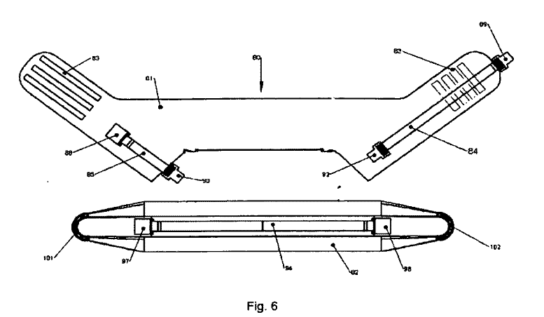

Further, in another embodiment, the outer legs (11) are connected to the beveled legs (12) through a hinge (17) as illustrated in FIG. 5. Said outer legs can then be pivoted sideways through a mechanical gear about the hinge (17). Moreover, said mechanical gear has at least one pedal (18) as illustrated in FIG. 5.

Further the wheeled E-shaped base frame means comprises rear wheelbases (20), rear castor means (21), front wheelbases (22) and front castor means (23). At the open end of the base frame (10), each outer leg (11) is provided with a rear wheelbase (20) having rear castor means (21). Further, at the front end of the base frame (10), more exactly, on each of the beveled legs (12) or on the U-shaped frame; a front wheelbase (22) having front castor means (23); is provided. The wheelbases (20, 22) interact with the castor means (21, 23). Said castor means (21, 23) may include pivot wheels, which comprise two wheels. In a preferred embodiment the front castor means (23) is provided with wheels that have a larger diameter that wheels of the rear castor means (21), thus the front wheelbase (22) is positioned on each of the beveled legs (12) or on the U-shaped frame and extends upwardly a predetermined length. Afterward said front wheel base (22) is bended outwardly from the base frame (10) and at one of its narrow ends is provided with front castor means (23).

Further, both castor means embodiments include a braking mechanism (not illustrated) for rotation and swivel. Moreover, said braking mechanism is connected to a common pedal (not illustrated).

The support column means comprises a slightly inclined column (30) towards the front end of the base frame (10). The column (30) is welded or attached by any other suitable means to the base frame (10) and extends upwardly from the middle leg (14). Further, the support column means comprises a handgrip (31), pivoted about a pivot (32); a pair of bracket plates (33), where each bracket plate has a cavity about a horizontal axis (B) and an elongated guide slot (38).

In a preferred embodiment a shin pad (35) is attached to shin support plates (34) and is pivoted about a pivot pin or bolt (36) located through the elongated guide slot (38), as illustrated in FIG. 1a.

In another embodiment a shin pad (35) is ergonomically designed and is fixed attached to shin support plates (34), as illustrated in FIG. 5. Said shin pad (35) has a large front surface giving a comfortable support to the different sizes of legs and has collateral supports on its sides and on the middle avoiding that the legs moves sideways.

The handgrip (31), which is pivoted about a pivot (32), is secured to the upper end of the support column (30). The handgrip (31) is provided in order to constitute assisting means, for instance when a patient wants to be raised from a sitting position. If so, the handgrip (31) can be pivoted about the pivot (32) to a position that is reachable to the patient and thereafter shifting the centre of gravity of the patient.

In a preferred embodiment, the lifting mechanism means comprises a U-shaped lifting arm (40), a pair of bracket sleeves (41), attaching means (42), adjustment apertures (43), a sling (80) and an actuator (45); wherein the actuator (45) is a power driven linear actuator, a lockable gas spring actuator or a manually driven actuator.

In another embodiment, the lifting mechanism means comprises a U-shaped lifting arm (40), a pair of bracket sleeves (41), attaching means (42), adjustment apertures (43), a sling (80), connecting means (44), a slidable holder (39) arranged around the support column (30), two guide plates (37) and an actuator (45); wherein the actuator (45) is a power driven linear actuator, a lockable gas spring actuator or a manually driven actuator.

The U-shaped lifting arm (40) is provided with two laterally spaced arms and one horizontal cross arm. The two laterally spaced arms are provided with at least one attaching means (42) at their outer ends in order to provide attachment points for a sling (80). The horizontal cross arm is pivotably connected about a horizontal axis (B) between the bracket plates (33), as illustrated in FIG. 1b. Moreover, the U-shaped lifting arm (40) is provided with the pair of bracket sleeves (41), which sleeves are welded or attached by any other suitable means to the U-shaped lifting arm (40) forming an angle (alfa), where (alfa) is preferably in the range from approximately 100° to approximately 130°, as illustrated in FIG. 1a. Each of the bracket sleeves (41) has a plurality of adjustment apertures (43).

In a preferred embodiment, these apertures (43) are lined up with one another to receive a pivot pin or bolt (36), which connects the extendible end of the actuator (45) with the bracket sleeves (41). The actuator (45) is connected at its lower end to a two guide plates (15) by a pivot pin or bolt (36). The two guide plates (15) are welded or attached by any other suitable means on the base frame (10), more exactly on the front leg (13), as illustrated in FIG. 1b.

In another embodiment, a gear mechanism is arranged an designed as illustrated in FIG. 5, wherein the apertures (43) are lined up with one another to receive a pivot pin or bolt (36), which connects one end of the connecting means (44) with the bracket sleeves (41) and the other end of the connecting means (44) is connected by a pivot pin or bolt to the slidable holder (39). Further, the actuator (45) is connected at its lower end to said slidable holder (39) by a pivot pin or bolt and at its extendible end to the two guide plates (37) that are welded or attached by any other suitable means to the upper end of the support column (30).

A control box means (50), which is electrically connected to a power driven linear actuator, is preferably attached by suitable means to the lowest end of the column (30) in order to obtain a lower centre of gravity. The control box means (50) is also preferably adapted to contain a programmable control means that controls the movement of the power driven linear actuator (45) and a battery pack if the aid apparatus is about to be used when there is no access to external power. The battery pack is preferably charged through on a remote control that is adapted to communicate with the control means. A man skilled in the art is also in this case capable of connecting the battery pack on a charge mode in another suitable known way.

The movement of the U-shaped lifting arm (40) is controlled by the person who is to be moved, or by a care giver, for instance, by the means of a switch. Such a switch is preferably designed so that the extendible part of the actuator (45) can be moved hick and forth, i.e. be pivoted upwards as well as downwards about its hinge. In one embodiment having a power driven linear actuator, such a switch is also provided on the remote control that is adapted to communicate with the control box means.

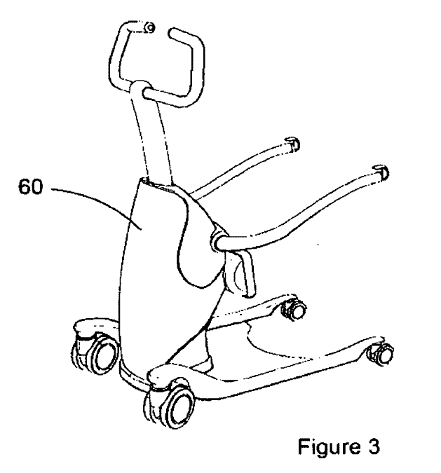

The slightly inclined column (30), the pair of bracket plates (33), a part of the U-shaped lifting arm (40); the pair of bracket sleeves (41), the actuator (45) and/or the control box means (50) are covered by a waterproof cover (60) as illustrated in FIG. 3.

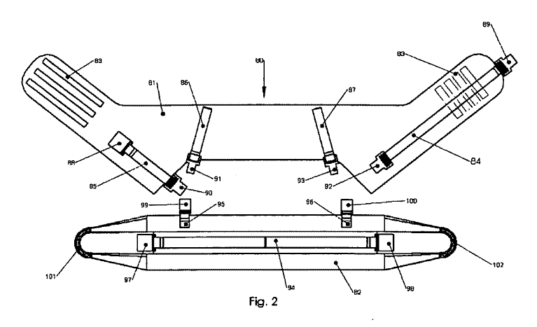

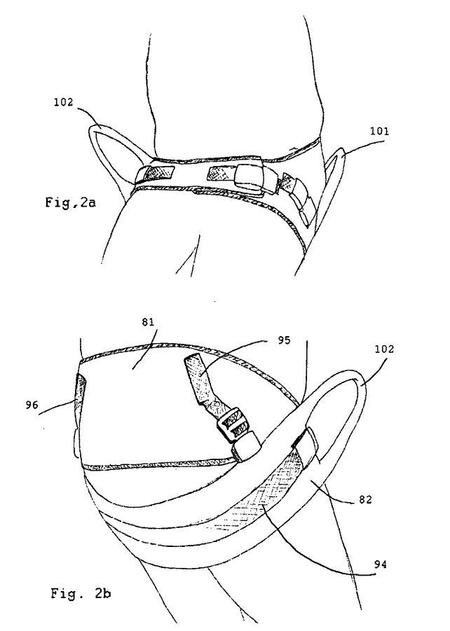

A preferred embodiment of a sling (80) will be described by reference to FIG. 2-2b. The sling (80) comprises a waist strap (81) and a thigh strap (82). The waist strap (81) comprises fastening means (83) of the Velcro® type for being adjustable around the waist of a patient. Further, the waist strap (81) comprises reinforcement bands (84, 85, 86, 87) with buckles (88, 89, 90, 91, 92 and 93). The thigh strap (82) comprises reinforcement bands (94, 95 and 96) with buckles (97, 98, 99 and 100). The thigh strap (82) has further at its lateral ends, two reinforced lifting bands (101, 102) for attachment to the attaching means (42) of the U-shaped lifting arm (40). When the sling (80) is fastened to a patient, the waist strap (81) is surrounded around the waist of the patient and secured through fastening the fastening means (83) of the Velcro® type to each other and fastening the buckles (88) and (89) to each other, the thigh strap (82) is placed under the thighs of the patient an the buckles on the thigh strap (82) are fastened as following: the buckle (97) is attached to the buckle (90), the buckle (98) is attached to the buckle (92), the buckle (95) is attached to the buckle (91) and the buckle (100) is attached to the buckle (93).

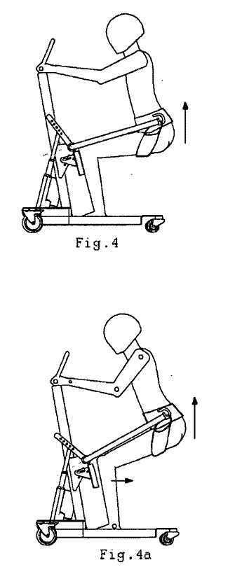

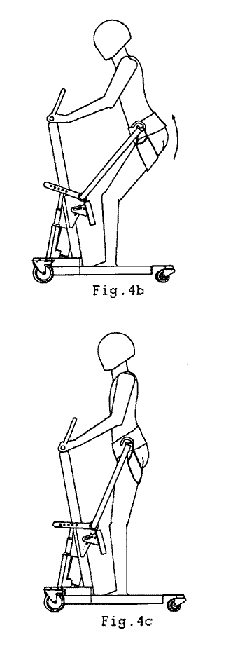

In reference to FIG. 4, as is it desired to raise a patient into a standing position. The waist strap (81) is surrounded and secured around the waist of the patient; the thigh strap (82) is surrounded around the thighs of the patient and secured to the waist strap. As the straps are secured and drawn tighten, the aid apparatus, with its U-shaped lifting arm in the fully lowered or nearly fully lowered position, is wheeled into a position in front of the seated patient. The feet of the patient are optionally placed on the footplate (16) until the upper shins of the patient make a slightly contact to the shin pad. The brakes of the castor means are applied by the care giver to hold the aid apparatus still. The reinforced lifting bands (101, 102) of the thigh strap (82) are attached to the attaching means (42) of the U-shaped lifting arm. The handgrip (31) is moved to a position for encouraging the seated patient to hold on to it so that his centre of gravity is shifted forward. The patient holds on to the handgrip (31) and the actuator (45) can then be actuated by the control means, to start lifting the patient into a standing position.

Another embodiment of a sling (80) will be described by reference to FIG. 6. The sling (80) comprises a waist strap (81) and a thigh strap (82). The waist strap (81) comprises fastening means (83) of the Velcro® type for being adjustable around the waist of a patient. Further, the waist strap (81) comprises reinforcement bands (84, 85) with buckles (88, 89, 90, and 92). The thigh strap (82) being made preferably of plastic having minimal friction surfaces and rounded edges in order to position said seat support under the patient thighs when said patient is in a sitting position. Further, said thigh strap (82) comprises a reinforcement hand (94) with buckles (97, 98). The thigh strap (82) has further at its lateral ends, two reinforced and adjustable lifting bands (101, 102) for attachment to the attaching means (42) of the U-shaped lifting arm (40). When the sling (80) is fastened to a patient, the waist strap (81) is surrounded around the waist of the patient and secured through fastening the fastening means (83) of the Velcro® type to each other and fastening the buckles (88) and (89) to each other, the thigh strap (82) is placed under the thighs of the patient an the buckles on the thigh strap (82) are fastened as following: the buckle (97) is attached to the buckle (90) and the buckle (98) is attached to the buckle (92).

In reference to FIG. 4a-4b, due to the patient shifted centre of gravity, the movement of the U-shaped lifting arm (40) transfers a slightly backward component of motion to the shins of the patient, a slightly forward component of motion to the waist strap and a major upward component of motion to the thigh strap.

Once the patient is raised into a substantially standing position as illustrated in FIG. 4c, the aid apparatus can be wheeled by the patient himself if he has still some mobility or in the other case the patient, whose feet are placed on the footplate (16), can be moved by a care giver.

Even though the inventive aid apparatus has been described to be used in the home environment of a disabled person, it is to be understood that the aid apparatus according to the present invention can also be used in any environment of choice, such as a hospital or within a special care living arrangement.

It is to be understood that the above described and illustrated embodiment of the present invention is to be regarded as a non-limiting example and that it can be modified within the scope of the patent claims.

1.-15. (canceled)

16. An aid apparatus for raising and lowering a patient between a sitting position and a standing position, comprising:
a wheeled base frame;
a support column device, comprising a column slightly inclined toward a front end of the wheeled base frame and a handgrip positioned on the slightly inclined column at a distance that encourages the patient when seated to hold the handgrip so that the patient's center of gravity is shifted forward; and
a lifting mechanism, comprising a sling that includes a waist strap and a thigh strap, a U-shaped lifting arm that includes two laterally spaced arms and one pivoted horizontal cross arm, a pair of attaching devices positioned at outer ends of the two laterally spaced arms for attaching the sling;
wherein the U-shaped lifting arm is configured to be moved by an actuator in order to lift the patient from a sitting position into a standing position; and due to the patient's shifted center of gravity, movement of the U-shaped lifting arm transfers a backward component of motion to the patient's shins, a forward component of motion to the waist strap, and an upward component of motion to the thigh strap.

17. The aid apparatus of claim 16, wherein the waist strap is adapted to impart a forward movement to the patient's upper body, and the thigh strap is adapted to impart an upward movement to the patient's upper body.

18. The aid apparatus of claim 16, wherein the horizontal cross arm of is positioned at substantially a same level as the knees of the patient when seated.

19. The aid apparatus of claim 16, wherein the two laterally spaced arms are positioned substantially parallel to the thighs of the patient when seated.

20. The aid apparatus of claim 16, wherein the waist strap is configured to be secured around the patient's waist.

21. The aid apparatus of claims 16, wherein the thigh strap is configured to be positioned under the patient's thighs, to be secured to the waist strap, and to be adjustably attached to the attaching devices.

22. The aid apparatus of claim 16, wherein the actuator is a power driven linear actuator, a lockable gas spring actuator, or a manually driven actuator.

23. The aid apparatus of claim 22, wherein an extendible end of the actuator is connected to the U-shaped lifting arm, and a lower end of the actuator is connected to the wheeled base frame.

24. The aid apparatus of claim 22, wherein an extendible end of the actuator is connected to the slightly inclined column, and a lower end of the actuator is connected to the U-shaped lifting arm through a gear mechanism.

25. The aid apparatus of claim 16, further comprising a controller; wherein the actuator is a power driven linear actuator, and the controller is electrically connected to the power driven linear actuator; whereby a heaviest part of the power driven linear actuator and the controller are positioned at a lowest end of the support column device to obtain a lower center of gravity.

26. The aid apparatus of claim 25, wherein the slightly inclined column, a portion of the U-shaped lifting arm, the actuator, and the controller are covered by a waterproof cover.

27. The aid apparatus of claim 16, wherein all metallic components and joints of the aid apparatus are treated to avoid corrosion.

28. The aid apparatus of claim 16, further comprising a footplate configured to be attached to the wheeled base frame, wherein the footplate is pivotable or removable.

29. The aid apparatus of claim 16, further comprising a front castor mechanism and a rear castor mechanism that are adapted to be attached to the wheeled base frame, wherein wheels of the front castor mechanism have a larger diameter than wheels of the rear castor mechanism.

30. The aid apparatus of claim 16, further comprising outer legs configured to be pivoted sideways through a mechanical gear.
